(19) United States
(12) Patent Application Publication
(10) Pub. No.: US 2012/0219331 A1
(43) Pub. Date: Aug. 30, 2012

(54) IMAGE FORMING UNIT AND IMAGE FORMING APPARATUS

(75) Inventor: Atsushi KOBAYASHI, Tokyo (JP)

(73) Assignee: OKI DATA CORPORATION, Tokyo (JP)

(21) Appl. No.: 13/404,305

(22) Filed: Feb. 24, 2012

(30) Foreign Application Priority Data
Feb. 28, 2011 (JP) 2011-041935

(51) Int. Cl. G03G 15/08

(52) U.S. Cl. 399/279

(57) ABSTRACT

An image forming unit includes a cylindrical rotatable image carrier that holds an electrostatic latent image, a cylindrical rotatable developer carrier that develops the held electrostatic latent image on the image carrier, and a cylindrical rotatable developer supplying member that supplies a developer to the developer carrier. Distance controlling members control the distance between axes of the image carrier and the developer carrier. A developer carrier gear is fixed on the developer carrier. A developer supplying member gear is fixed on the developer supplying member. A cylindrical rotatable idle gear engages with the developer carrier gear and the developer supplying member gear. A link member maintains constant the distance between rotational axes of the developer supplying member and the idle gear. Another link member maintains constant the distance between rotational axes of the developer carrier gear and the idle gear. A connecting member connects the two link members.

### CROSS-REFERENCE TO RELATED APPLICATION

This application claims priority under 35 U.S.C. §119 from Japanese Patent Application NO. P 2011-041935, filed on Feb. 28, 2011, the disclosure of which is incorporated herein by reference.

### BACKGROUND OF THE INVENTION

1. Field of the Invention

This application relates to an image forming unit and an image forming apparatus.

2. Description of the Related Art

In an image forming unit or an image forming apparatus such as a printer, a copy machine, a fax machine, and a combined machine, for example, in the image forming unit, a developer image is fixed on a sheet by following processes. An electrostatic latent image is formed by a LED (Light Emitting Diode) head exposing a surface of an image drum as an image carrier charged equally by a charging roller, and a developer image is formed onto the image drum by a developing unit developing the electrostatic latent image. Then, the developer image is transferred to a sheet by a transfer roller, and the developer image is fixed on the form by a fuser.

In the developing unit, a developing roller as a developer carrier is provided to transfer a developer to the electrostatic latent image, a developer supplying roller is provided to supply a developer to the developing roller, and a developer image is formed by a contact development method.

In an image forming unit that performs a contact development method, a pressure caused by the image drum contacting the developing roller, i.e., a pressure of abutment (which corresponds to the degree of) must be set to an appropriate amount. If the pressure of abutment is insufficient, problems such as over-dyeing or a dead pixel may occur. Also, if the pressure of abutment is excessive, other problems, such as filming or deterioration of the developer may occur. As a result, image quality will decrease.

Therefore, it may be considered to set the pressure of abutment between the image drum and the developing roller to appropriate amount by increasing the dimensional accuracy and accuracy of assembly of each component, such as the image drum, the developing roller, and a supporting unit. However, if the dimensional accuracy and accuracy of assembly of each component are increased, not only does the productivity of the image forming unit decrease, but also the cost of the image forming unit increases.

In Japanese Laid-Open Patent No. 2006-048018, the following method of preventing the above problems is described. First, a distance control member is provided in the image forming unit to control a distance between the rotational axis of the image drum and the rotational axis of the developing roller, and the image forming unit, configured, for example with the image drum, the charging roller, and the developing unit is assembled. Then, in the process of manufacturing the image forming unit, a thin film is inserted into a contact portion between the image drum and the developing roller, and a measurement is taken of tension on the film caused by surface friction drag upon actuation of the image drum and the developing roller in the image forming apparatus. Then, the pressure of abutment between the image drum and the developing roller is controlled by the distance control member to set the tension at the appropriate amount by moving the rotational axis of the developing roller relative to the rotational axis of the image drum.

However, in the above-described image forming unit, engaging between a developing roller gear fixed on one end of the developing roller and an idle gear is produced by movement of the rotational axis of the image roller.

As a result, rotation of the developing roller is not constant, so that the quality of the developer image is degraded, causing a reduction of image quality.

A purpose of this application is to disclose an image forming unit and an image forming apparatus that may increase image quality by resolving the problems of related image forming units described above and controlling the pressure of abutment between the image carrier and the developing roller.

### SUMMARY OF THE INVENTION

An object of the application is to disclose an image forming unit and an image forming apparatus capable of increasing image quality.

According to one aspect, an image forming unit may include a cylindrical rotatable image carrier that holds an electrostatic latent image, a cylindrical rotatable developer carrier that develops the held electrostatic latent image on the image carrier, and a cylindrical rotatable developer supplying member that supplies a developer to the developer carrier. Distance controlling members control the distance between rotational axes of the image carrier and the developer carrier. A developer carrier gear is fixed on one end of the developer carrier. A developer supplying member gear is fixed on one end of the developer supplying member. A cylindrical rotatable idle gear engages with the developer carrier gear and the developer supplying member gear. A link member maintains constant the distance between rotational axes of the developer supplying member and the idle gear. Another link member maintains constant the distance between rotational axes of the developer carrier gear and the idle gear. A connecting member connects the two link members.

According to another aspect, an image forming apparatus may include an image forming unit. The image forming unit may include a cylindrical rotatable image carrier that holds an electrostatic latent image, a cylindrical rotatable developer carrier that develops the held electrostatic latent image on the image carrier, and a cylindrical rotatable developer supplying member that supplies a developer to the developer carrier. Distance controlling members control the distance between rotational axes of the image carrier and the developer carrier. A developer carrier gear is fixed on one end of the developer carrier. A developer supplying member gear is fixed on one end of the developer supplying member. A cylindrical rotatable idle gear engages with the developer carrier gear and the developer supplying member gear. A link member maintains constant the distance between rotational axes of the developer supplying member and the idle gear. Another link member maintains constant the distance between rotational axes of the developer carrier gear and the idle gear. A connecting member connects the two link members.

### BRIEF DESCRIPTION OF THE DRAWINGS

The image forming unit and the image forming apparatus will be more fully understood from the following detailed description with reference to the accompanying drawings, which is given by way of illustration only, and is not intended to limit the invention, wherein:

FIG. 1 is an exploded perspective view of one end of an image forming unit according to a first embodiment;

FIG. 2 is a conceptual diagram of a printer according to the first embodiment;

FIG. 3 is a conceptual diagram of the image forming unit according to the first embodiment;

FIG. 4 is an exploded perspective view of the other end of the image forming unit according to the first embodiment;

FIG. 5 is a perspective view of a link mechanism according to the first embodiment;

FIG. 6 is an exploded perspective view of the link mechanism according to the first embodiment;

FIG. 7 is a view illustrating a behavior of the link mechanism according to the first embodiment;

FIG. 8 is a first view illustrating a distance between the rotational axis of an image drum and the rotational axis of a developing roller according to the first embodiment;

FIG. 9 is a second view illustrating a distance between the rotational axis of an image drum and the rotational axis of a developing roller according to the first embodiment;

FIG. 10 is an exploded perspective view of one end of an image forming unit according to a second embodiment;

FIG. 11 is an exploded perspective view of the other end of the image forming unit according to the second embodiment;

FIG. 12 is a view illustrating a behavior of the link mechanism according to the second embodiment;

FIG. 13 is a view illustrating a distance between the rotational axis of an image drum and the rotational axis of a developing roller according to the second embodiment; and

FIG. 14 is a view illustrating a movement of the rotational axis of a developer supplying roller according to the second embodiment.

### DETAILED DESCRIPTION OF THE INVENTION

Embodiments will be described particularly with reference to the figures. In embodiments, a printer will be described as an exemplary embodiment of an image forming apparatus according to the invention.

### First Embodiment

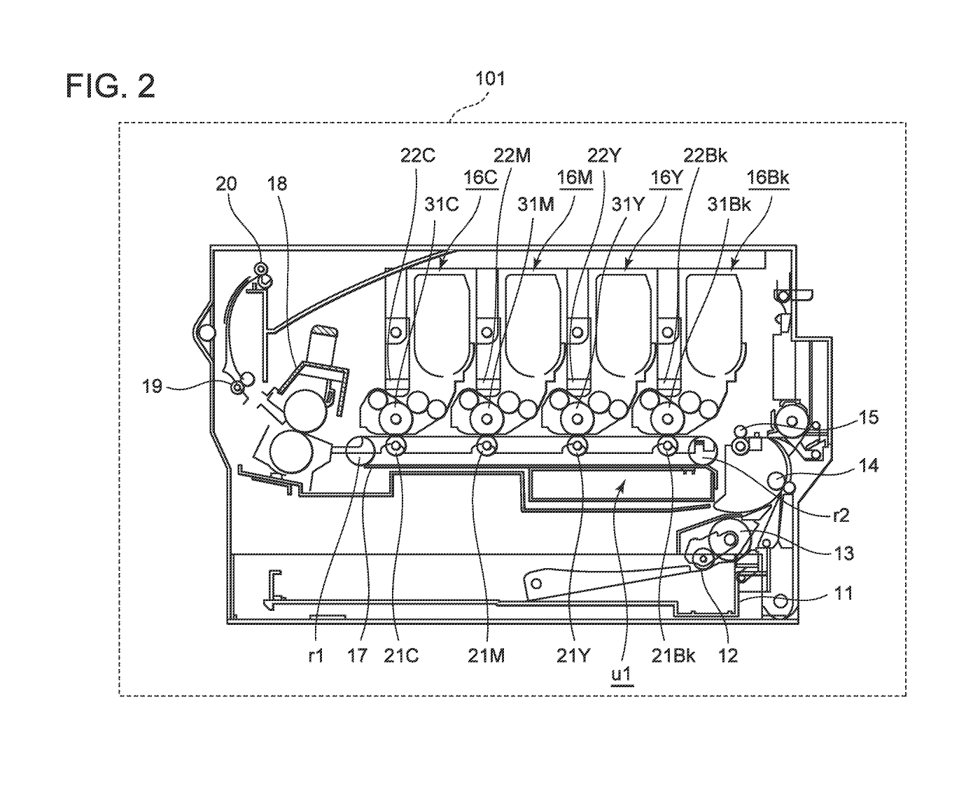

FIG. 2 is a conceptual diagram of a printer 101 as the image forming apparatus according to the first embodiment.

As shown in FIG. 2, a paper feeding cassette 11 as a media storage may be arranged in the bottom of the printer, and sheets of paper or other media may be stored in a horizontal orientation in the paper feeding cassette 11. It is noted initially that in this embodiment (and in a second embodiment described below), the printer elements are oriented so that the width of the sheets always extend in a horizontal direction as they pass though the printer. Thus, all rotatable elements involved in transferring the paper, developer and images during a printing process rotate about horizontal axes). However, the inventors contemplate that other orientations of the sheets and printer elements are possible, as will be readily apparent from the present disclosure to those skilled in the art, and the scope of the invention therefore is not limited by the horizontal orientations of these embodiments.

Referring again to FIG. 2, a paper feeding mechanism that separates and feeds individual sheets abuts the front edge of the paper feeding cassette 11. The paper feeding mechanism may include a paper feeding roller 12 and a separate roller 13. The sheets fed by the paper feeding mechanism may be transferred to a feeding roller 14 arranged on the upper side of the paper feeding mechanism, and then may be transferred to a feeding roller 15. Then the sheets may be transferred sequentially in a horizontal direction to image forming units 16Bk, 16Y, 16M, and 16C, which form respective images of each color such as Black, Yellow, Magenta, and Cyan. Here, the image forming unit 16Bk is for Black, the image forming unit 16Y is for Yellow, the image forming unit 16M is for Magenta, and the image forming unit 16C is for Cyan.

An image drum 31Bk is for Black, an image drum 31Y is for Yellow, an image drum 31M is for Magenta, and an image drum 31C is for Cyan. The image drums 31Bk, 31Y, 31M, and 31C hold respective electrostatic latent images as latent images, and may be arranged respectively in the image forming units 16Bk, 16Y, 16M, and 16C. An LED head 22Bk is for Black, a LED head 22Y is for Yellow, a LED head 22M is for Magenta, and a LED head 22C is for Cyan. The LED heads 22Bk, 22Y, 22M, and 22C may be exposure devices that form the electrostatic latent images by exposing each surface of the image drums 31Bk, 31Y, 31M, and 31C. The LED heads 22Bk, 22Y, 22M, and 22C may be arranged respectively to respectively abut the image forming units 16Bk, 16Y, 16M, and 16C, and respectively face the image drums 31Bk, 31Y, 31M, and 31C.

A transfer unit u1 may be arranged along the image forming units 16Bk, 16Y, 16M, and 16C. The transfer unit u1 also may include a drive roller r1, a driven roller r2, a transfer belt 17 as a transfer unit entrained by the drive roller r1 and the driven roller r2, and arranged to rotate freely, and transfer rollers 21Bk, 21Y, 21M, and 21C respectively arranged to hold the transfer belt 17 respectively with the image drums 31Bk, 31Y, 31M, and 31C. The transfer roller 21Bk is for Black, and may be arranged against the image drum 31Bk. The transfer roller 21Y is for Yellow, and may be arranged against the image drum 31Y. The transfer roller 21M is for Magenta, and may be arranged against the image drums 31M. The transfer roller 21C is for Cyan, and may be arranged against the image drums 31C.

The sheets may be transferred with the transfer belt 17, and may run through the image forming unit 16Bk, 16Y, 16M, and 16C and the transfer roller 21Bk, 21Y, 21M, and 21C. In the meantime, the transfer rollers 21Bk, 21Y, 21M, and 21C may transfer each color toner as a developer formed by the image forming unit 16Bk, 16Y, 16M, and 16C, to each sheet, and then a color toner image may be formed thereon.

The sheet may be transferred to a fuser 18 which fixes the color toner image on the sheet so that a color image is formed. Then the sheet is ejected from the fuser 18 and transferred by a transfer roller 19 to an ejection transfer roller 20, which ejects the printed sheet from the printer 101.

Next, the image forming units 16Bk, 16Y, 16M, and 16C will be described. Here, only the image forming units 16Bk will be described, and explanations of the image forming units 16Y, 16M, and 16C will be omitted, because the image forming units 16Bk, 16Y, 16M, and 16C each have identical mechanisms.

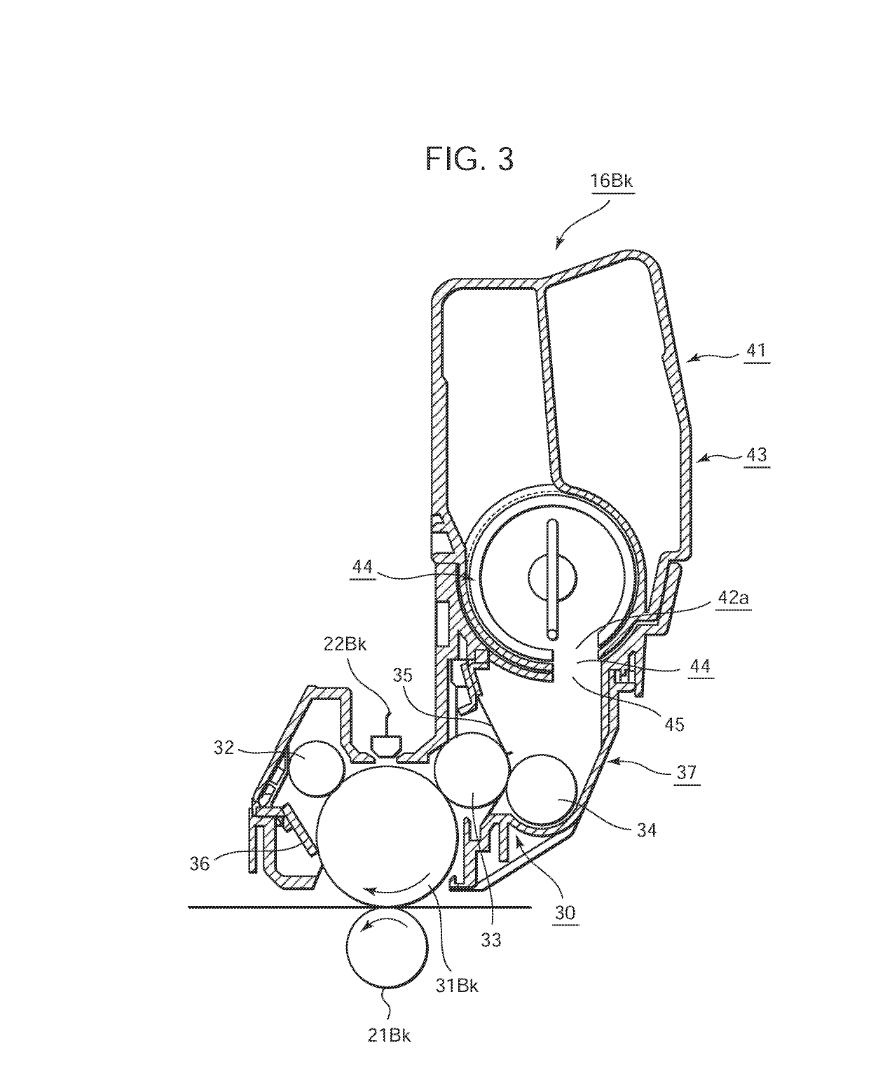

FIG. 3 is a conceptual diagram of the image forming unit 16Bk according to the first embodiment. FIG. 3 illustrates a movable toner cartridge 41 arranged on a body of an image forming unit 37 that is part of the image forming unit 16Bk. The toner may be fed from the toner cartridge 41 to a developing unit 30 arranged in the body of the image forming unit 37. Therefore, a toner supplying port 44 may be formed at a lower surface of a case 43 which is a container for the developer of the toner cartridge 41. Also, a shutter 42 may be arranged to open and close the toner supplying port 44. In this embodiment, the shutter 42 may be arranged rotatable. An opening portion 42a may be formed at the shutter 42. The toner supplying port 44 may be opened by turning a control lever (not illustrated) to move (turn) the shutter 42 so as to align the toner supplying port 44 with the opening portion 42a. Also, the toner supplying port 44 may be closed by turning the control lever to turn the shutter 42 so as to cause the toner supplying port 44 to become misaligned with the opening portion 42a.

A concave mounting surface (not illustrated in FIG. 3) is formed in the body of the image forming unit 37 to assemble the toner cartridge 41. Also, a developer supply port 45 corresponding to the toner supplying port 44 is formed at the mounting surface. Therefore, if the toner supplying port 44 is opened, toner in the toner cartridge 41 is fed into the body of the image forming unit 37 through the toner supply port 45.

The image forming unit 16Bk may include an image drum 31Bk, a charging roller 32, a developing roller 33, a toner supplying roller 34, a developing blade 35, and a cleaning blade 36. The charging roller 32 serves as a charging unit to charge evenly a surface of the image drum 31Bk. The developing roller 33 serves as a developer carrier to hold a toner, and supplies the toner to the image drum 31Bk, and may form a toner image by developing an electrostatic latent image. The toner supplying roller 34 serves as a developer supplying member to supply the toner to the developing roller 33. The developing blade 35 acts to reduce the thickness of the toner fed onto the developing roller. The cleaning blade 36 scrapes residual toner from the image drum 31Bk after the toner image has been transferred. The developing unit 30 may include parts such as the developing roller 33, the toner supplying roller 34, and the developing blade 35.

The image drum 31Bk may be formed by cladding a hollow roller (conductive base layer) made of a material such as aluminum with an organic photoreceptor surface layer. The charging roller 32 may be formed by cladding a solid conductive metallic cylinder with a semiconductive rubber such as epichlorohydrin rubber. The developing roller 33 may be formed by cladding a solid conductive metallic cylinder with a semiconductive rubber such as silicone rubber. The toner supplying roller 34 may be formed by cladding a solid conductive metallic cylinder with a rubber formed by addition of a blowing agent which is kneaded to roughen the surface so as to increase the ease with which the toner is fed.

The charging roller 32, the developing roller 33, and the cleaning roller 36 may be arranged to contact the image drum 31Bk. The toner supplying roller 34 and the developing blade 35 may be arranged to contact the developing roller 33. An unillustrated power source for the developing roller 33 may be contact with the developing roller 33, and may apply a bias voltage thereto. Power sources (not illustrated) in for the toner supplying roller 34 and developing blade 35 may be contact therewith to apply a bias voltages thereto.

In the running of the printer, both the developing roller 33 and the toner supplying roller 34 may be rotated in a counterclockwise fashion by an unillustrated drive motor, and a toner may be fed to the developing roller 33 by the toner supplying roller 34. The toner fed to the developing roller 33 may be transferred to the contact portion between the developing roller 33 and the developing blade 35 by rotation of the developing roller 33. The developing blade 35 may scrape excess toner from the developing roller 33, and laminate the residual toner on the developing roller 33. Then the laminated toner on the developing roller 33 may be transferred to the image drum 31Bk while the developing roller 33 rotates.

The image drum 31Bk may be rotated in a prescribed direction by an unillustrated drive motor as a drive member for image forming. While the image drum 31Bk is rotating, its surface may be charged evenly by the charging roller 32, an electrostatic latent image may be formed on the surface thereof by exposure to the LED head 22Bk, and a toner image may be formed by toner on the developing roller 33 being attached electrically to the electrostatic latent image.

Next, ways of supporting and rotating each roller, such as the image drum 31Bk, the charging roller 32, the developing roller 33, and the toner supplying roller 34, will be described.

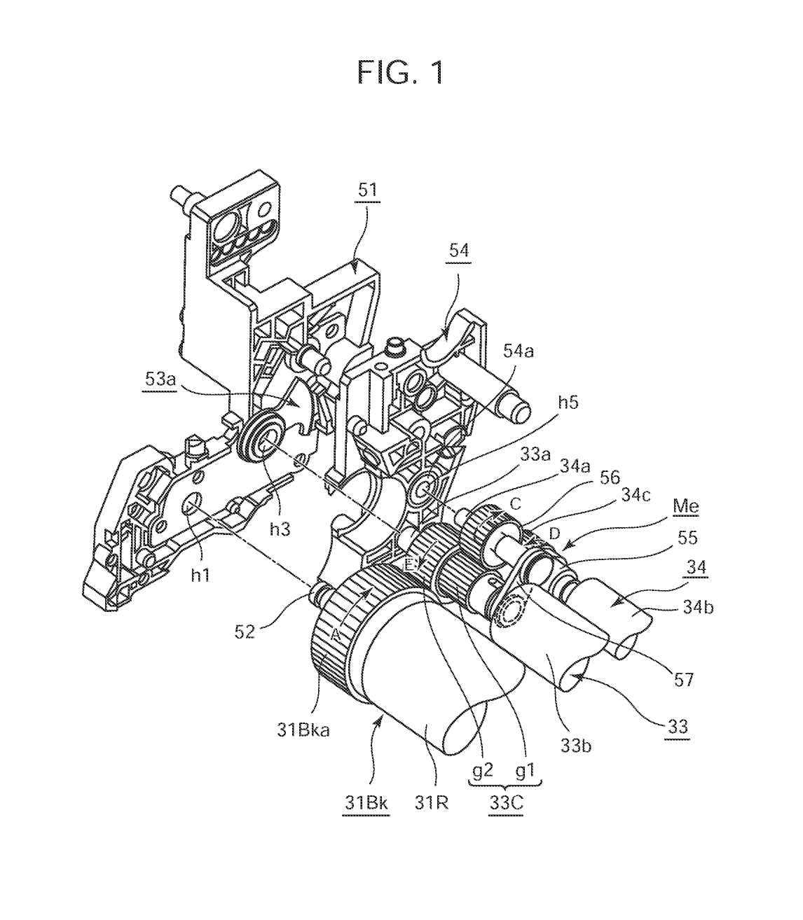

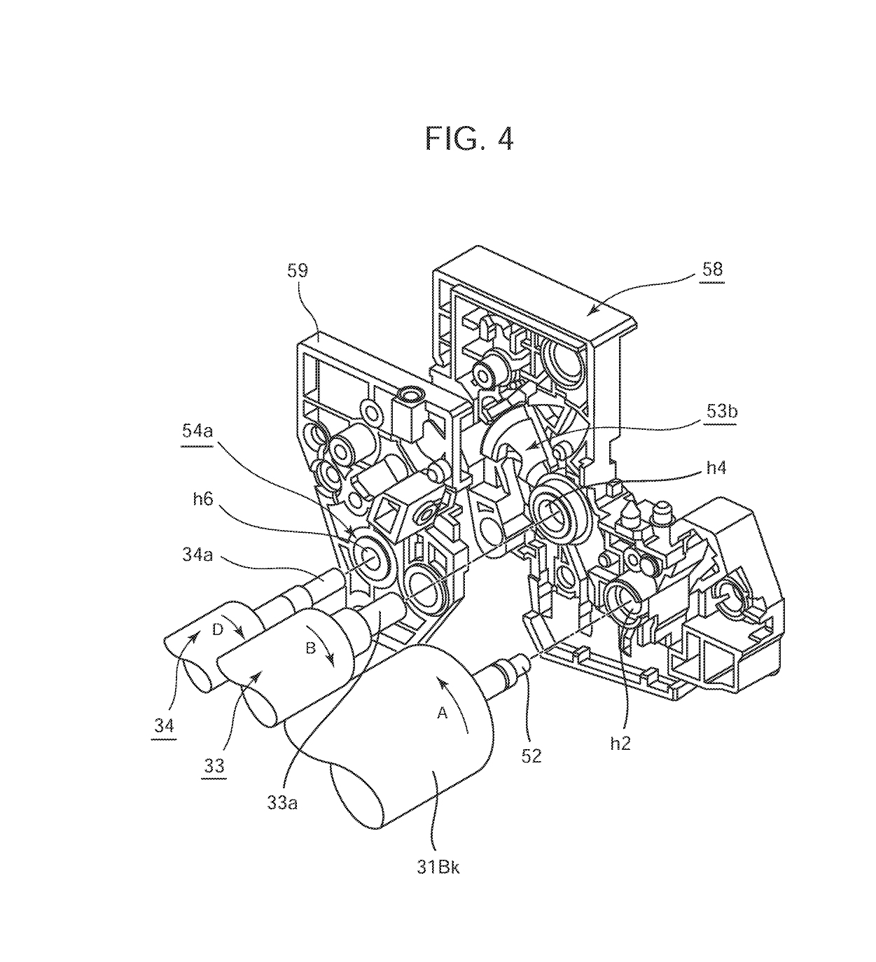

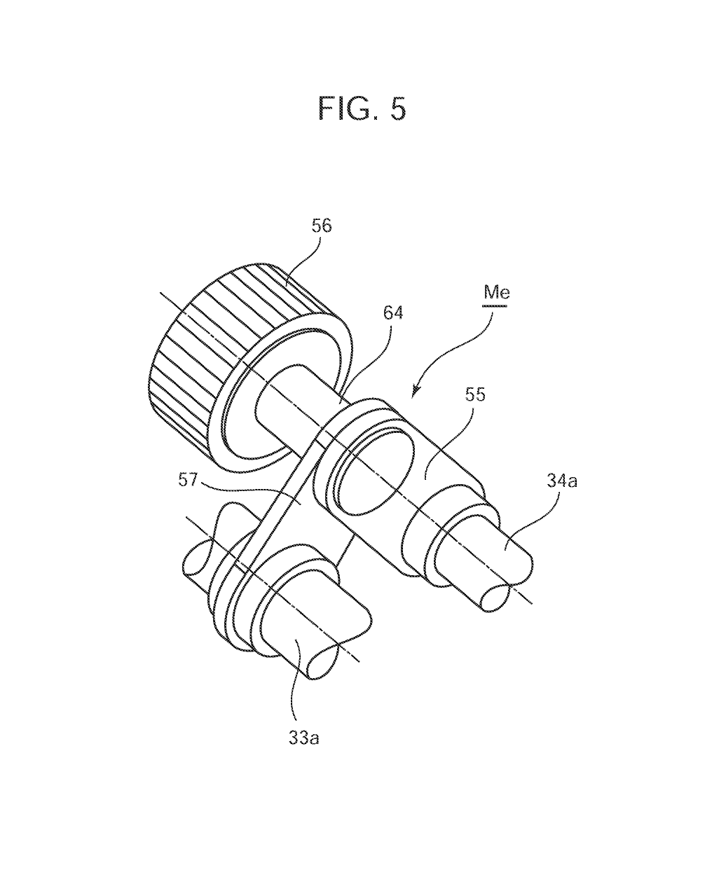

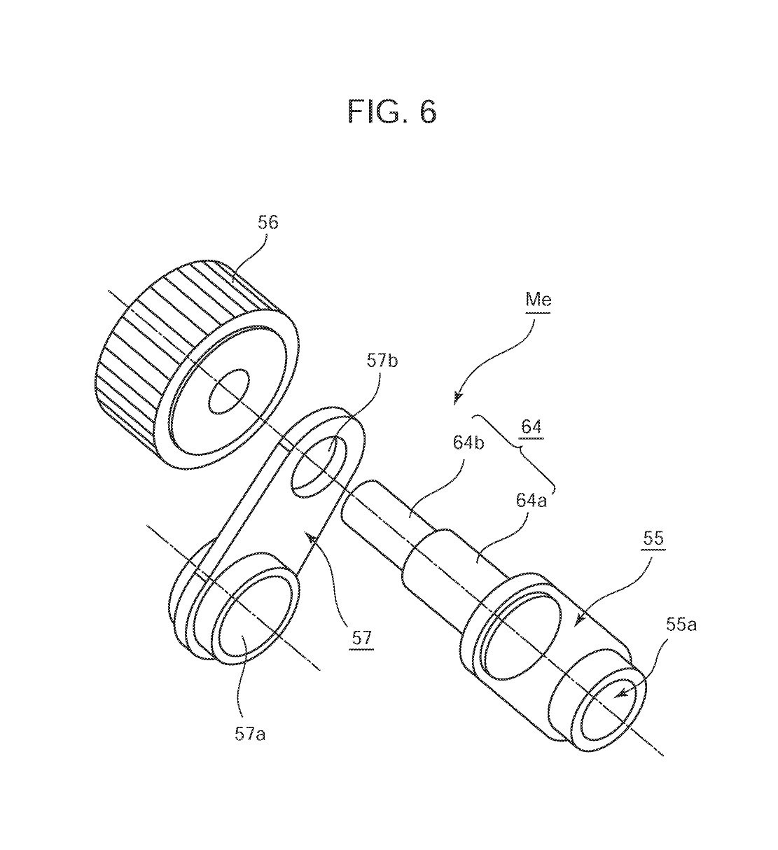

FIG. 1 is an exploded perspective view of one end of the image forming unit 16Bk according to the first embodiment. FIG. 4 is an exploded perspective view of the other end of the image forming unit 16Bk according to the first embodiment. FIG. 5 is a perspective view of a link mechanism Me according to the first embodiment. FIG. 6 is an exploded perspective view of the link mechanism Me according to the first embodiment.

The image drum 31Bk may include a hollow roller 31R, an image drum gear 31Bka, and an unillustrated flange. The image drum gear 31Bka may be fixed concentrically on the hollow roller 31R. The flange may be fixed concentrically on the hollow roller 31R at an end edge of the hollow roller 31R. Both ends of the image drum 31Bk may be supported rotatably against side frames 51 and 58 that form a chassis of the body of the image forming unit 37.

Therefore, the side frames 51 and 58 may have respective fitting holes h1 and h2 at prescribed positions, and the image drum gear 31Bka and the flange may have respectively unillustrated latching holes. Also, one end of each of the metallic shafts 52 may be fixed respectively in the fitting holes h1 and h2, and the other ends thereof may be respectively latched in a rotatable condition in the latching holes of the image drum gear 31Bka and the flange.

The developing roller 33 may include a shaft member 33a, a rubber member 33b, and a developing roller gear 33c. The shaft member 33a may be a solid cylinder. The rubber member 33b clads the shaft member 33a. The developing roller gear 33c is an image carrier gear fixed concentrically on the end of the shaft member 33a.

The developing roller gear 33c may engage the toner supplying roller 34 by engaging with an idle gear 56. Rotation of the developing roller 33 may be transferred to the toner supplying roller 34 with deceleration of the rotation of the developing roller 33. Therefore, the developing roller gear 33c may be a two-speed gear that includes a small gear g1 and a small gear g2. The number of teeth of the small gear g1 that engages with the idle gear 56 may be less than the number of teeth of the idle gear 56. The number of teeth of the small gear g2 that engages with the image drum gear 31Bk may be greater than the number of teeth of the small gear g1.

The developing roller 33 may be positioned against the image drum 31Bk with a prescribed pressure of abutment, with its rotational axis parallel to the rotational axis of the image drum 31Bk.

Distance controlling members 53a and 53b that are bearings for the developing roller 33 may be arranged at prescribed positions of the side frames 51 and 58. The shaft member 33a may be supported rotatably in holes h3 and h4 respectively formed in the distance controlling members 53a and 53b. If the distance controlling members 53a and 53b are swung, the positions of the holes h3 and h4 against the side frame 51 and 58 are respectively changed, and the rotational axis of the developing roller 33 is moved toward the image drum 31Bk. Rotational axes of the distance controlling members 53a and 53b do not match central axes of the holes h3 and h4. As a result, the distance between the rotational axis of the image drum 31Bk and the developing roller 33, that is the distance between the rotational axis of the image drum 31Bk and the rotational axis of the developing roller 33, may be changed, and a pressure of abutment between the image drum 31Bk and the developing roller 33 may be controlled.

The toner supplying roller 34 may include a shaft member 34a, a rubber member 34b, and a toner supplying roller gear 34c. The shaft member 34a may be a solid cylinder. The rubber member 34b may clad the shaft member 34a. The toner supplying roller gear 34c may be fixed concentrically on the end of the shaft member 34a, and may engage with the idle gear 56.

The toner supplying roller 34 may be arranged with its rotational axis parallel to that of the developing roller 33 and in contact therewith, with a prescribed pressure of abutment.

Inside frames 54 and 59 may be respectively arranged inside of the side frames 51 and 58. The inside frame 54 and the side frame 51, and the inside frame 59 and the side frame 58 may be respectively positioned and fitted by unillustrated position restricting posts fitted on unillustrated restricting holes.

Bearing members 54a for the toner supplying roller 34 may be fitted on the prescribed positions of the inside frame 54 and 59. The shaft member 34a may supported rotatably in holes h5 and h6 formed in the respective bearing members 54a.

In this way, the image drum 31Bka may engage with the developing roller gear 33c, the developing roller gear 33c may engage with the idle gear 56, and the idle gear 56 may engage with the toner supplying roller gear 34c. Therefore, if the drive motor is driven in the body of the printer, i.e., in the body of the image forming apparatus, the rotation of the drive gear connected with the drive motor is transferred to the image drum gear 31Bka, the developing roller gear 33c, the idle gear 56, and the toner supplying roller gear 34c. Then the image drum gear 31Bka and the image drum 31Bk may be rotated in the direction A, the developing roller gear 33c and the developing roller 33 are rotated in the direction B, the idle gear 56 may be rotated in the direction C, and the toner supplying roller gear 34c and the toner supplying roller 34 rotate in the direction D.

The developing roller gear 33c, the idle gear 56, and the toner supplying roller gear 34c may be connected to each other through a link mechanism Me. The link mechanism Me may include a first link member 55, a second link member 57, and a post member 64. The first link member 55 connects the idle gear 56 with the toner supplying roller gear 34c. The second link member 57 connects the developing roller gear 33c with the idle gear 56. The post member 64, as a connecting member, connects the first link member 55 with the second link member 57, and supports the second link member 57 in a swingable manner against the first link member 55. The post member 64 is fixed on the first link member 55 so that the central axis of the post member 64 is parallel to rotational axes of the developing roller 33 and the toner supplying roller 34. Also, the post member 64 may have two tier cylinders. In this arrangement, a first cylinder may be a post member 64a serving as a first supporting member, which has a large diameter. A second cylinder may be a post member 64b serving as a second supporting member of small diameter, which is formed in abutment with the post member 64a. The idle gear 56 may be supported rotatably by the post member 64b.

One end of the first link member 55 may have a first hole 55a that is slightly bigger than the outside diameter of the shaft member 34a. The other end of the first link member 55 may have a second hole (not illustrated in the drawings) that is slightly bigger than the outside diameter of the post member 64b, to fix the post member 64b on the other end thereof. One end of the second link member 57 may have a hole 57a that is slightly bigger than the outside diameter of the shaft member 33a. The other end of the first link member 55 may have a hole 57b that is slightly bigger than the outside diameter of the post member 64b.

In the first link member 55, the distance between the center of the first hole 55a and the center of the second hole may be set so that the idle gear 56 engages optimally with the toner supplying roller gear 34c. In the second link member 57, the distance between the center of the hole 57a and the center of the hole 57b may be set so that the developing roller gear 33c engages optimally with the idle gear 56.

In this case, in the first link member 55, a distance between the rotational axis of the toner supplying roller gear 34c and the rotational axis of the idle gear 56, i.e., a distance between the rotational axis of the toner supplying roller gear 34c and the rotational axis of the idle gear 56 may be maintained constant by maintaining constant the distance between the center of the first hole 55a and the center of the second hole. Also, in the second link member 57, the distance between the rotational axis of the developing roller gear 33c and the rotational axis of the idle gear 56, i.e., a distance between the rotational axis of the developing roller gear 34c and the rotational axis of the idle gear 56, may be maintained constant by maintaining constant the distance between the center of the hole 57a and the center of the hole 57b.

Therefore, if the distance between the image drum 31 and the developing roller 33 is controlled by the distance controlling members 53a and 53b being swung, the idle gear 56 may be supported at all times by the post member 64 at the position where the developing roller gear 33c can engage optimally with the idle gear 56, and the idle gear 56 can engage optimally with the toner supplying roller gear 34c. As a result, engaging between the developing roller gear 33c and the idle gear 56 and messing between the idle gear 56 and the toner supplying roller gear 34 remain firm.

Next, the method of controlling the pressure of abutment between the image drum 31Bk and the developing roller 33 in a manufacturing process will be described.

First, an operator may assemble the parts of the image forming unit 16Bk, including for example the image drum 31Bk, the charging roller 32, the developing member 30, and the cleaning blade 36 into the body of the image forming unit 37. Then, the operator may insert a thin film into a contact portion between the image drum 31Bk and the developing roller 33, and may measure a tension in the film that occurs based on a frictional drag on surfaces of the image drum 31Bk and the developing roller 33 while the image forming unit 16Bk is running. Then, the operator may rotate the distance controlling members 53a and 53b so that the amount of tension is appropriate, and may move with relative movement of the rotational axis of the developing roller 33 with respect to the rotational axis of the image drum 31Bk. As a result, the pressure of abutment between the image drum 31Bk and the developing roller 33 is controlled.

While the pressure of abutment between the drum 31Bk and the roller 33 is being controlled, if the rotational axis of the developing roller 33 is moved toward or away from the drum 31Bk, the shaft member 33a moves in the same direction, the second link member 57 may turn, and the post member 64 may be moved vertically. Then, if the post member 64 is moved vertically, the first link member 55 turns, and the shaft member 34a and toner supplying roller 34, which are fixed longitudinally and axially, turn.

During such movements, the developing roller gear 33c may continue to engage with the idle gear 56, and the idle gear 56 may continue to engage with the toner supplying roller gear 34c. As a result, the engaging between the developing roller gear 33c and the idle gear 56, and between the idle gear 56 and the toner supplying roller gear 34c is maintained firm.

Next, the behavior of the link mechanism Me in cases in which the distance between the rotational axis of the image drum 31Bk and the rotational axis of the developing roller 33 becomes shorter and longer will be described.

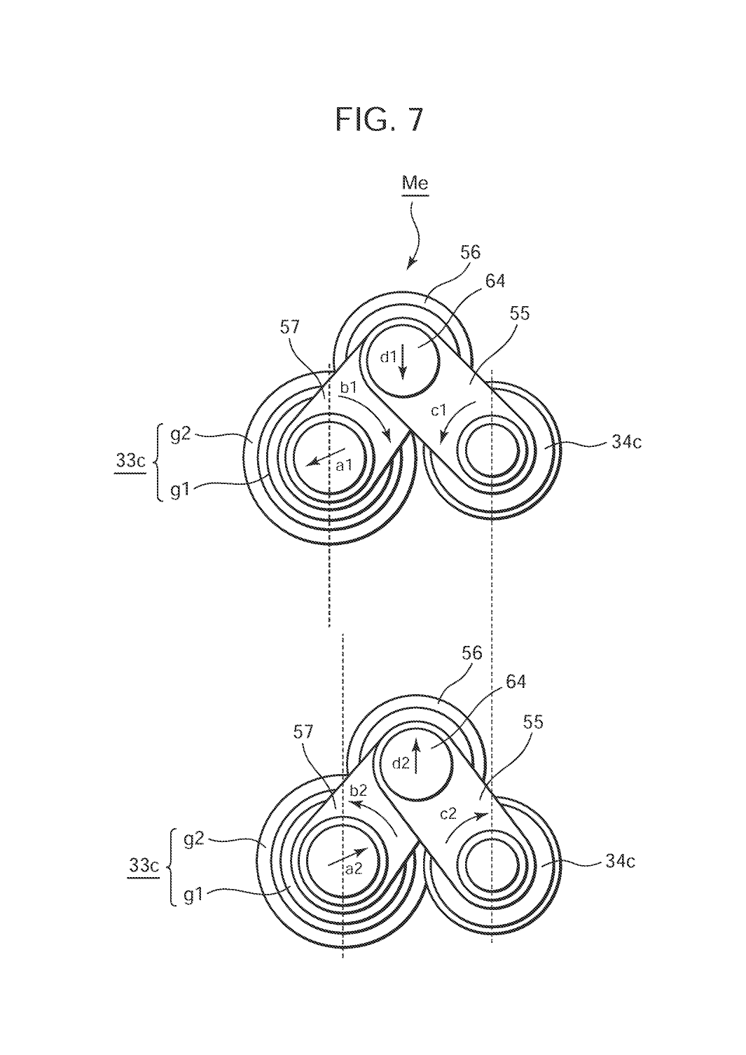

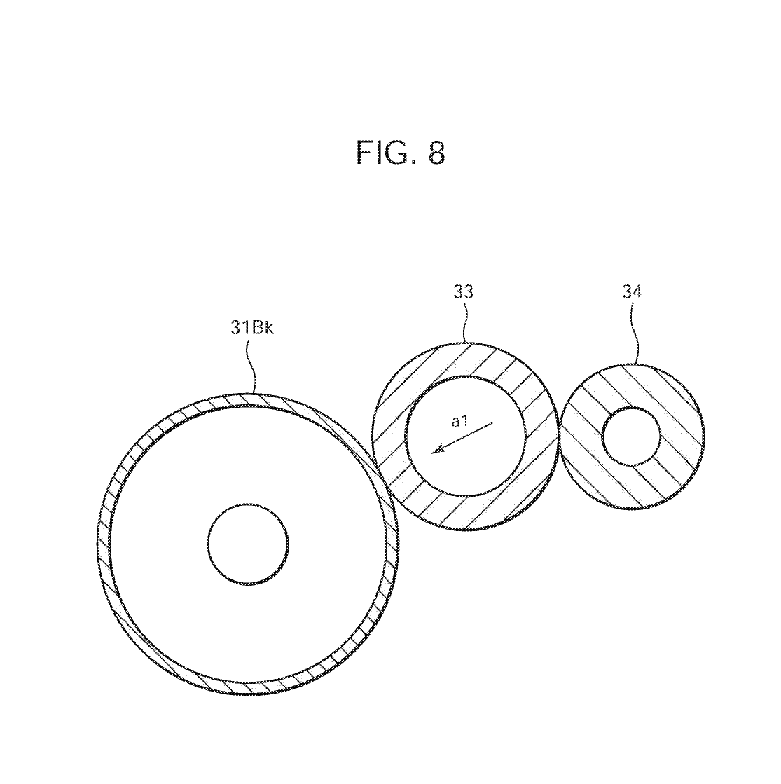

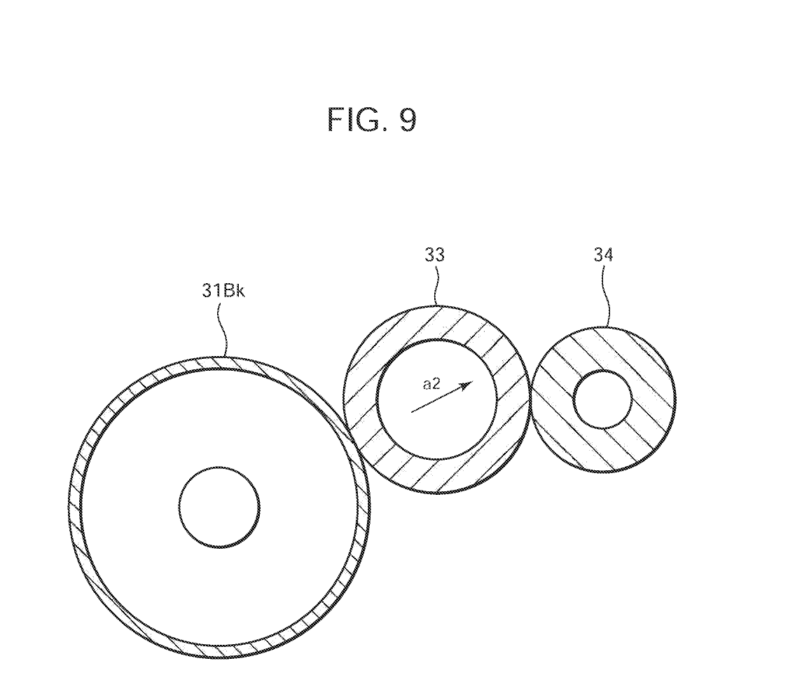

FIG. 7 is a view illustrating the behavior of the link mechanism according to the first embodiment. FIG. 8 is a first view illustrating the distance between the rotational axis of the image drum 31Bk and the rotational axis of the developing roller 33 according to the first embodiment. FIG. 9 is a second view illustrating the distance between the rotational axis of the image drum 31Bk and the rotational axis of the developing roller 33 according to the first embodiment.

As shown in FIG. 8, if the distance between the rotational axis of the image drum 31Bk and the rotational axis of the developing roller 33 becomes shorter, the rotational axis of the developing roller 33 may be moved in the directional toward the rotational axis of the image drum 31Bk. During axial movement in the directions a1 of the developing roller gear 33c, as shown in FIG. 7, the second link member 57 rotates in the direction b1, the first link member 55 rotates in the direction c1, and the post member 64 and the idle gear 56 move vertically in the direction d1.

As shown in FIG. 9, to lengthen the distance between the rotational axis of the image drum 31Bk and the rotational axis of the developing roller 33, the developing roller 33 may be moved in the direction a2 away from the image drum 31Bk. During axial movement in the direction a2 of the developing roller gear 33c, as shown in FIG. 7, the second link member 57 rotates in the direction b2, the first link member 55 rotates in the direction c2, and the post member 64 and the idle gear 56 move vertically in the direction d2.

In this embodiment, as described above, it may be possible to control the distance between the rotational axis of the image drum 31Bk and the rotational axis of the developing roller 33, and to provide an appropriate amount of the pressure of abutment between the image drum 31Bk and the developing roller 33, by turning of the distance controlling members 53a and 53b (illustrated in FIG. 1 and FIG. 4). As a result, it may be possible to prevent over-dyeing, dead pixels, and filming or deterioration of a toner, and to increase image quality.

Also, the distance between the rotational axis of the toner supplying roller gear 34c and the rotational axis of the idle gear 56 may be maintained constant by the first link member 55, the distance between the rotational axis of the developing roller gear 33c and the rotational axis of the idle gear 56 may be maintained constant by the second link member, and the first link member 55 may be connected with the second link member 57 by the post member 64. Therefore, if the distance between the rotational axis of the image drum 31Bk and the rotational axis of the developing roller 33 is controlled, the first and the second link members 55 and 57 are rotated, and the rotational axis of the idle gear 56 may be moved vertically. As a result, engagement between the developing roller gear 33c and the idle gear 56, and between the idle gear 56 and the toner supplying roller gear 34c may be held firm (fully engaged).

Therefore, in methods of rotation transmission created by engagement the developing roller gear 33c, the idle gear 56, and the toner supplying roller gear 34c with each other, it may be possible to prevent jitter from occurring between the developing roller gear 33c and the idle gear 56 or between the idle gear 56 and the toner supplying roller gear 34c, and to prevent a reduction in the durability of the developing roller gear 33c, the idle gear 56, and the toner supplying roller gear 34c.

### Second Embodiment

If the printer is used for a long time, the rubber member 34 becomes worn down, and the outside diameter of the toner supplying roller 34 becomes smaller. During use of the printer, if the rotational axis of the toner supplying roller 34 is fixed on the inside frames 54 and 59, the pressure of abutment between the toner supplying roller 34 and the developing roller 33 is not maintained constant. According to features of the second embodiment, even if the rubber member 34 becomes worn down, and the outside diameter of the toner supplying roller 34 has become smaller, the pressure of abutment between the toner supplying roller 34 and the developing roller 33 remains constant. Thus, elements identical to those of the first embodiment will be designated by same reference numbers, and results based on inclusion of the identical elements will be incorporated herein by reference.

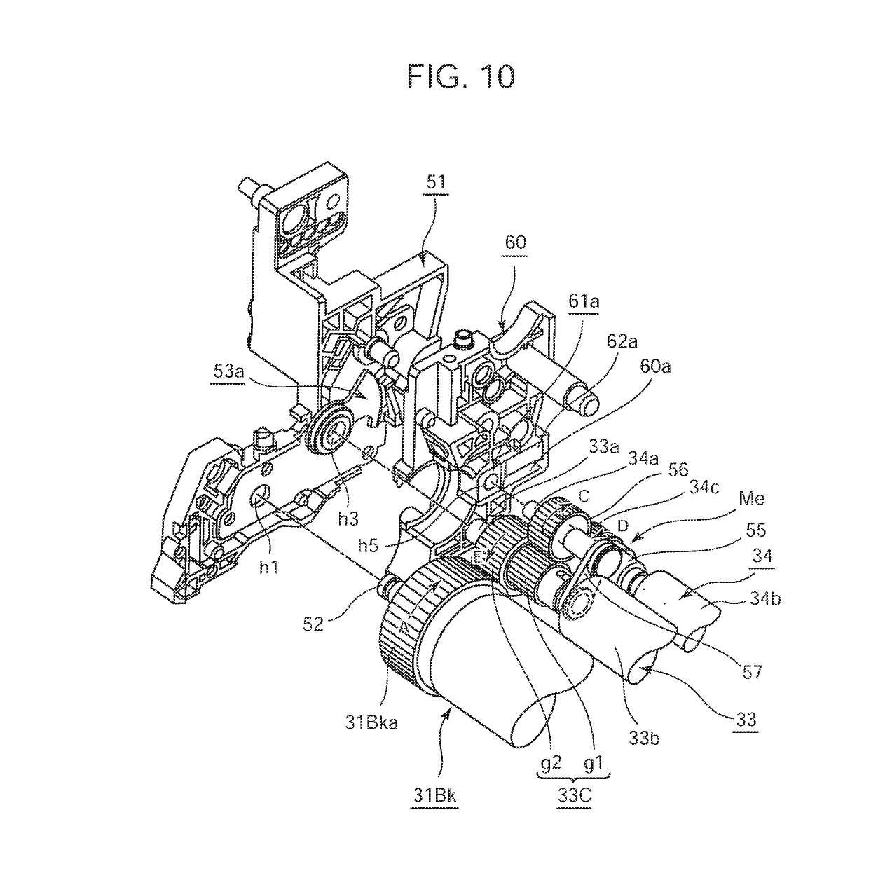

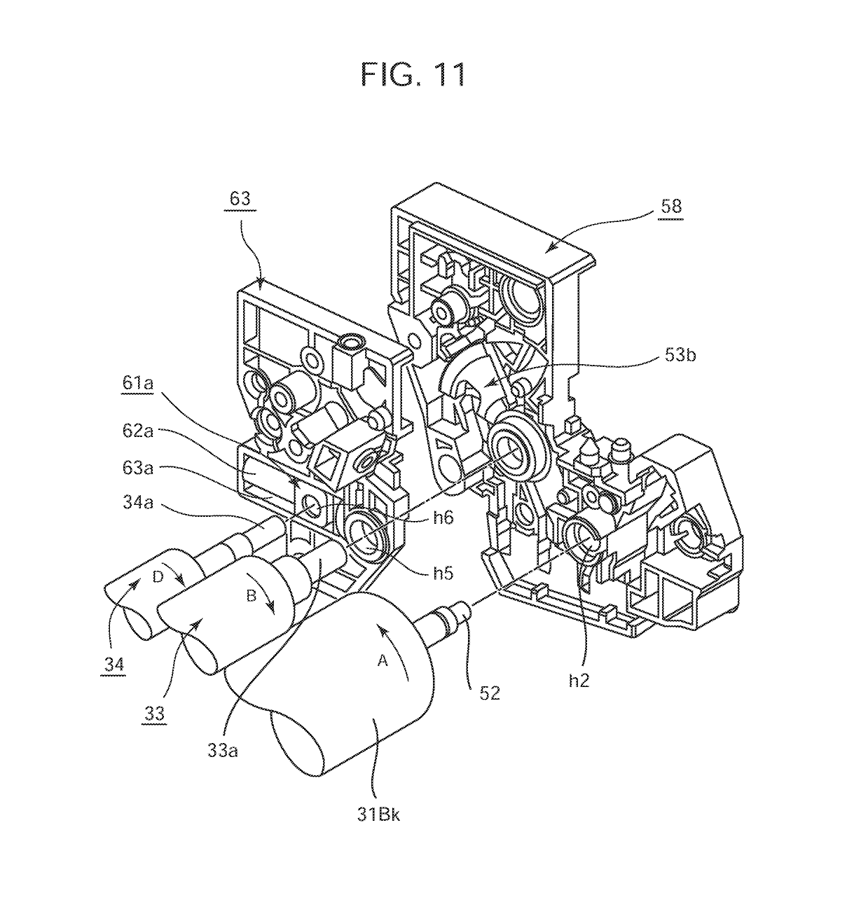

FIG. 10 is an exploded perspective view of a one end of an image forming unit 16Bk according to a second embodiment. FIG. 11 is an exploded perspective view of the other end of the image forming unit 16Bk according to the second embodiment.

Inside frames 60 and 63 may be respectively arranged inside of the side frames 51 and 58. The inside frame 60 and the side frame 51, and the inside frame 63 and the side frame 58 may be respectively positioned and fitted by unillustrated position restricting posts fitted on unillustrated restricting holes.

Bearing members 61a for the toner supplying roller 34 may be arranged on the inside frames 60 and 63 in a movable condition in the horizontal direction of the inside frames 60 and 63, i.e., arranged on the line that connects the rotational axis of the developing roller 33 with the rotational axis of the toner supplying roller 34. The shaft member 34a may be supported in a rotatable condition in holes h5 and h6 formed in the respective bearing members 61a.

Grooves 60a and 63a that are parallel to the line that connects the rotational axis of the developing roller 33 with the rotational axis of the toner developing roller 34 may be arranged in the prescribed positions within the inside frames 60 and 63. Springs 62a serving as biasing members may be arranged in the grooves 60a and 63a in a movable condition, in the horizontal direction of the inside frames 60 and 63 and against insides of the grooves 60a and 63a. Also the springs 62a may contact the respective bearing members 61a. The height of the grooves 60a and 63a may be slightly longer than a distance between a top surface that is a first face of bearing member 61a and a bottom surface that is a second face thereof, so that the bearing members 61a are movable in the respective grooves 60a and 63a. The depth of the grooves 60a and 63a may be slightly longer than the length of the bearing member 61 in the axis direction of the shaft member 34a. The length of the grooves 60a and 63a in the horizontal direction of the inside frames 60 and 63 may be set so that the grooves 60a and 63a can hold the bearing members 61a and the springs 62a, and the bearing members 61 are movable in the horizontal direction of the inside frames 60 and 63.

The springs 62a may arranged so that one end of each contacts the side surface of the bearing member 61a, and the other ends thereof respectively contact the inside surfaces of the grooves 60a and 63a. Also, the bearing members 61a are each biased toward the rotational axis of the developing roller 33 so that the toner supplying roller 61a may contact the developing roller 33 with a prescribed pressure. Thus, the springs 62a may be weak, and it may be possible to produce only small changes of a biasing pressure against displacement of the springs.

Next, the method of controlling the pressure of abutment between the image drum 31Bk and the developing roller 33 in a manufacturing process will be described.

First, an operator may assemble the parts of the image forming unit 16Bk, including for example the image drum 31Bk, the charging roller 32, the developing member 30, and the cleaning blade 36 into the body of the image forming unit 37 (illustrated in FIG. 3). Then, the operator may insert a thin film into a contact portion between the image drum 31Bk and the developing roller 33, and may measure a tension in the film that occurs based on a frictional drag on surfaces of the image drum 31Bk and the developing roller 33 while the image forming unit 16Bk is running. Then, the operator may rotate the distance controlling members 53a and 53b so that the amount of tension is appropriate, and may move with relative movement of the rotational axis of the developing roller 33 with respect to the rotational axis of the image drum 31Bk. As a result, the pressure of abutment between the image drum 31Bk and the developing roller 33 is controlled.

While the pressure of abutment between the drum 31Bk and the roller 33 is being controlled, if the rotational axis of the developing roller 33 is moved toward or away from the drum 31Bk, the shaft member 33a moves in the same direction, the second link member 57 may turn, and the post member 64 may be moved vertically. Then, if the post member 64 is moved vertically, the first link member 55 turns, the shaft member 34a and the toner supplying roller 34 may be moved horizontally.

During such movements, the developing roller gear 33c may engage with the idle gear 56, and the idle gear 56 may engage with the toner supplying roller gear 34c. As a result, the engaging between the developing roller gear 33c and the idle gear 56, and between the idle gear 56 and the toner supplying roller gear 34c is maintained firm.

The bearing members 61a may respectively be biased toward the rotational axis of the developing roller 33 by the spring members 62a, and may respectively be supported at a prescribed position so that the toner supplying roller 34 contacts the developing roller 33 with a prescribed pressure.

During use of the printer, if the printer is used for a long time, the rubber member 34 becomes worn down, and the outside diameter of the toner supplying roller 34 becomes smaller. However, as described above, the bearing member 61a may be biased toward the rotational axis of the developing roller 33 by the spring members 62a. Therefore, the rotational axis of the toner supplying roller 34 may be moved toward the rotational axis of the developing roller 33 while the outside diameter of the toner supplying roller 34 decreases, and may be supported at a prescribed position so that the toner supplying roller 34 contacts the developing roller 33 with a prescribed pressure. Thus, the spring 62a may stretch while the rotational axis of the toner supplying roller 34 moves horizontally. However, as described above, the springs 62a may be weak. Therefore, it may be possible to produce only small changes of a biasing pressure against displacement of the springs. Also, the pressure of abutment between the toner supplying roller 34 and the developing roller 33 may be maintained firm.

Next, the behavior of the link mechanism Me in cases in which the distance between the rotational axis of the image drum 31Bk and the rotational axis of the developing roller 33 becomes shorter and longer will be described.

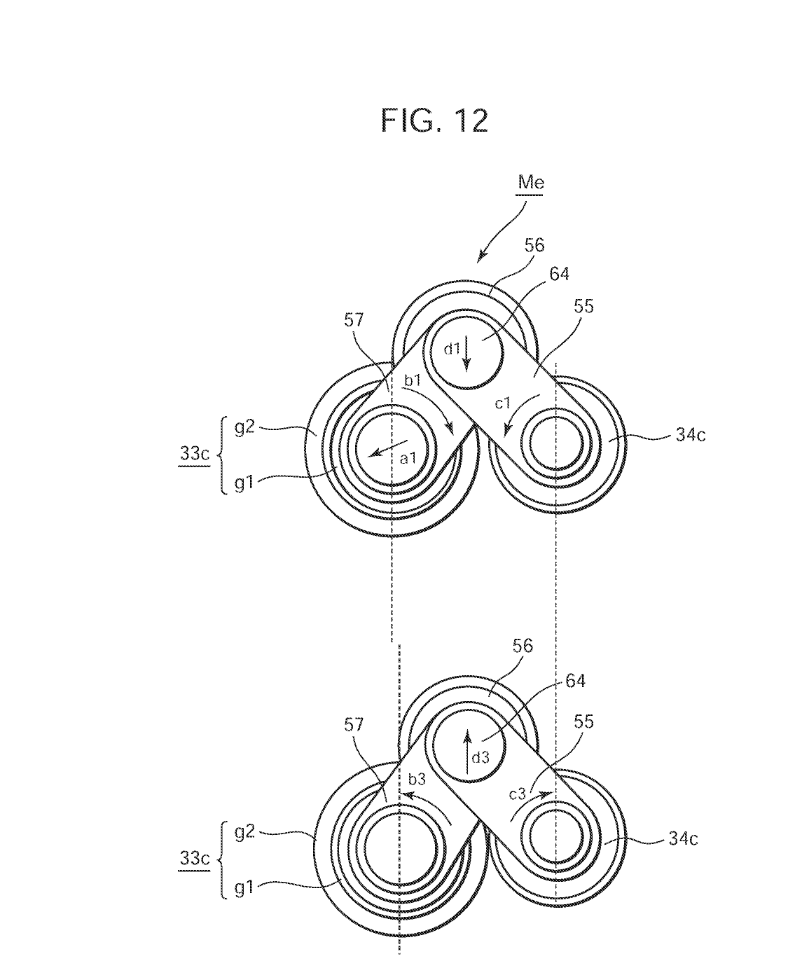

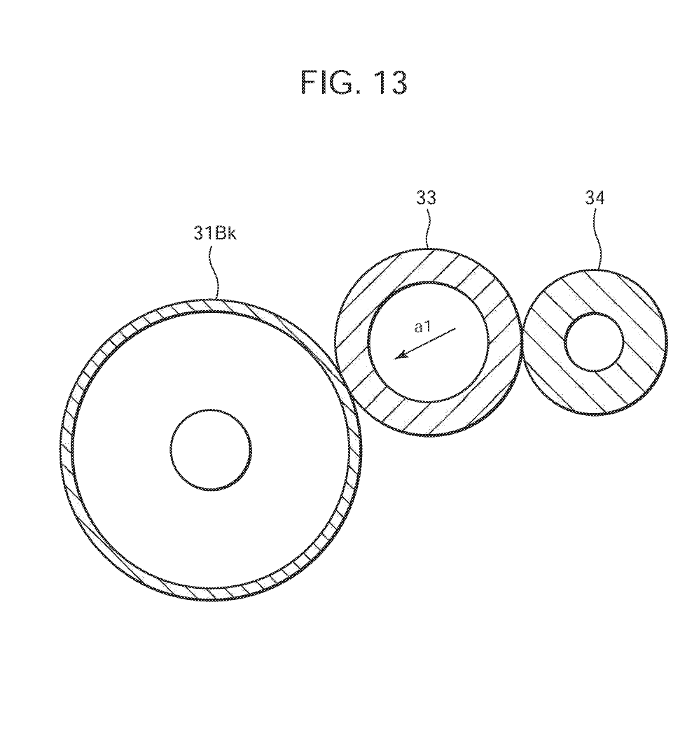

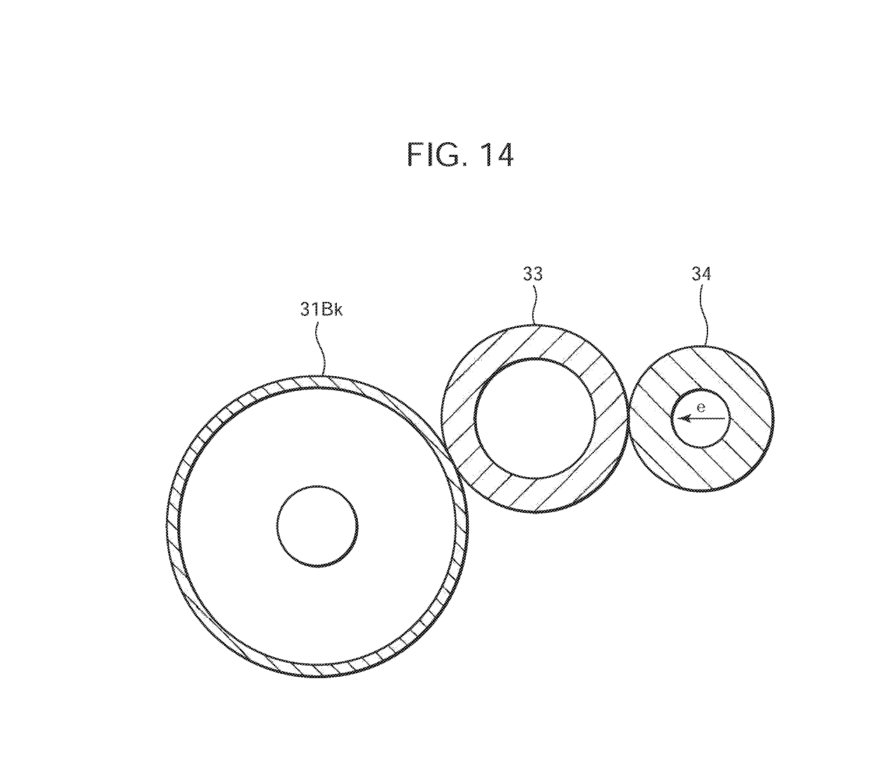

FIG. 12 is a view illustrating the behavior of the link mechanism Me according to the second embodiment. FIG. 13 is a view illustrating a distance between the rotational axis of the image drum 31Bk and the rotational axis of the developing roller 33 according to the second embodiment. FIG. 14 is a view illustrating movement of the rotational axis of the toner supplying roller 34 according to the second embodiment.

As shown in FIG. 13, if the distance between the rotational axis of the image drum 31Bk and the rotational axis of the developing roller 33 becomes shorter, the rotational axis of the developing roller 33 may be moved in the directional toward the rotational axis of the image drum 31Bk. During axial movement in the directional of the developing roller gear 33c, as shown in FIG. 12, the second link member 57 rotates in the direction b1, the first link member 55 rotates in the direction c1, and the post member 64 and the idle gear 56 move vertically in the direction d1.

As shown in FIG. 9, to lengthen the distance between the rotational axis of the image drum 31Bk and the rotational axis of the developing roller 33, the developing roller 33 may be moved in the direction a2 away from the image drum 31Bk. During axial movement in the direction a2 of the developing roller 33, as shown in FIG. 7, the second link member 57 rotates in the direction b2, the first link member 55 rotates in the direction c2, and the post member 64 and the idle gear 56 move vertically in the direction d2.

In addition, as described above in FIG. 14, if the rubber member 34 becomes worn down, and the rotational axis of the toner supplying roller 34 moves toward the rotational axis of the developing roller 33 in the direction e, the second link member 57 rotates in the direction b3, the first link member 55 rotates in the direction c3, and the post member 64 and the idle gear 56 move vertically in the direction d3.

As described above, in this embodiment, if the rubber member 34 of the toner supplying roller 34 becomes worn down, the rotational axis of the toner supplying roller 34 may be moved toward the rotational axis of the developing roller 33 while the outside diameter of the toner supplying roller 34 is decreasing. Therefore, the pressure of abutment between the toner supplying roller 34 and the developing roller 33 may be maintained firm.

In addition, if the distance between the rotational axis of the image drum 31Bk and the rotational axis of the developing roller 33 is controlled while the rotational axis of the toner supplying roller 34 is moving toward the rotational axis of the developing roller 33 and the outside diameter of the toner supplying roller 34 is decreasing, the first and second link members 55 and 57 turn, and the idle gear 56 moves vertically. As a result, the engagement between the developing roller gear 33c and the idle gear 56, and engagement between the idle gear 56 and the toner supplying roller gear 34c remain firm.

Therefore, in methods of transmitting rotation, it may be possible to prevent jitter from occurring between the developing roller gear 33c and the idle gear 56 or between the idle gear 56 and the toner supplying roller gear 34c, and to prevent a reduction in the durability of the developing roller gear 33c, the idle gear 56, and the toner supplying roller gear 34c.

In the embodiments, the printer serving as the image forming apparatus was described. However, the embodiments may be applied to a copy machine, a fax machine, and a combined machine.

An invention based on the embodiments is not limited within only the described embodiments, the invention may be formed in various shapes, and shapes are included within the scope of the invention.

As described above, the image forming unit 16Bk may include the image drums 31Bk serving as the image carrier configured to support the electrostatic latent image, the developing roller 33 serving as the developer carrier configured to develop the formed electrostatic latent image on the image carrier, the toner supplying roller 34 serving as the developer supplying member configured to supply the developer to the developer carrier, the distance controlling member 53a, and 53b configured to control the distance between the rotational axis of the developer carrier and the rotational axis of the image carrier, the developing roller gear 33c serving as the developer carrier gear fixed on one end of the developer carrier, the toner supplying roller gear 34c serving as the developer supplying member gear fixed on one end of the developer supplying member, the idle gear 56 configured to engage the developer carrier gear and the developer supplying member gear, the first link member 55 configured to maintain constant the distance between the rotational axis of the developer supplying member and the rotational axis of the idle gear 56, the second link member configured to maintain constant the distance between the rotational axis of the developer carrier gear and the rotational axis of the idle gear 56, and the post member 64 serving as the connecting member configured to connect the first link member 55 with the second link member 57.

In this case, the pressure of abutment between the developer carrier and the image carrier may be controlled based on controlling of the distance between the rotational axis of the developer carrier and the rotational axis of the image carrier by the distance controlling members 53a and 53b. Also, the distance between the rotational axis of the developer supplying member gear and the rotational axis of the idle gear 56 may be maintained constant by the first link member 55, the distance between the rotational axis of the developer carrier gear and the rotational axis of the idle gear 56 may be maintained constant by the second link member 55, and the first link member 55 may be connected with the second link member 57 by the connecting member. Therefore, if the distance between the rotational axis of the image carrier and the rotational axis of the developer carrier is controlled, the first and second link members 55 and 57 may be turned, and the idle gear 56 may be moved vertically. As a result, the engagement between the developer gear and the idle gear 56, and the engagement between the idle gear 56 and the developer supplying member gear remain firm. Also, in methods of transmitting rotation, it may be possible to prevent jitter from occurring between the developer carrier gear and the idle gear 56 or between the idle gear 56 and the developer supplying member gear, and to prevent a reduction in the durability of the developer carrier gear 33c, the idle gear 56, and the developer supplying member gear.

Therefore, it may be possible to increase image quality.

What is claimed is:

1. An image forming unit, comprising:
a cylindrical rotatable image carrier configured to hold an electrostatic latent image;
a cylindrical rotatable developer carrier configured to develop the held electrostatic latent image on the image carrier;
a cylindrical rotatable developer supplying member configured to supply a developer to the developer carrier;
a developer carrier gear fixed on the developer carrier;
a developer supplying member gear fixed on the developer supplying member;
a cylindrical rotatable idle gear configured to engage with the developer carrier gear and the developer supplying member gear; and
means for controlling a pressure of abutment between the image carrier and the developer carrier, including
distance controlling members configured to control the distance between the rotational axis of the image carrier and the rotational axis of the developer carrier,
a first link member configured to maintain constant the distance between the rotational axis of the developer supplying member and the rotational axis of the idle gear,
a second link member configured to maintain constant the distance between the rotational axis of the developer carrier gear and the rotational axis of the idle gear, and
a connecting member that connects the first link member with the second link member.

2. The image forming unit of claim 1, further comprising:
frames configured to support the image carrier, the developer carrier, and the distance controlling members at opposite ends thereof; and
bearing members respectively fixed on the frames to support the developer supplying member so that the developer supplying member is rotatable against the frames while keeping parallel to the image carrier and the developer carrier.

3. The image forming unit of claim 1, further comprising:
frames configured to support the image carrier, the developer carrier, and the distance controlling members at opposite ends thereof;
bearing members respectively fixed on the frames to support the developer supplying member so that the developer supplying member is rotatable against the frames while keeping parallel to the image carrier and the developer carrier; and
biasing members configured to respectively bias the bearing members toward a rotational axis of the developer carrier.

4. An image forming apparatus for producing an image on sheet media, comprising:
an image forming unit for producing a developed image, including
a cylindrical rotatable image carrier configured to hold an electrostatic latent image,
a cylindrical rotatable developer carrier configured to develop the held electrostatic latent image as the developed image on the image carrier,
a cylindrical rotatable developer supplying member configured to supply a developer to the developer carrier,
a developer carrier gear fixed on the developer carrier,
a developer supplying member gear fixed on the developer supplying member,
a cylindrical rotatable idle gear configured to engage with the developer carrier gear and the developer supplying member gear, and
means for controlling a pressure of abutment between the image carrier and the developer carrier, including
distance controlling members configured to control the distance between the rotational axis of the image carrier and the rotational axis of the developer carrier,
a first link member configured to maintain constant the distance between the rotational axis of the developer supplying member and the rotational axis of the idle gear,
a second link member configured to maintain constant the distance between the rotational axis of the developer carrier gear and the rotational axis of the idle gear, and
a connecting member that connects the first link member with the second link member; and
means for transferring the developed image from the image carrier to the sheet media.

5. The image forming apparatus of claim 4, wherein the image forming unit further includes
frames configured to support the image carrier, the developer carrier, and the distance controlling members at opposite ends thereof, and
bearing members respectively fixed on the frames to support the developer supplying member so that the developer supplying member is rotatable against the frames while keeping parallel to the image carrier and the developer carrier.

6. The image forming apparatus of claim 4, wherein the image forming unit further including
frames configured to support the image carrier, the developer carrier, and the distance controlling members at opposite ends thereof;
bearing members respectively fixed on the frames to support the developer supplying member so that the developer supplying member is rotatable against the frames while keeping parallel to the image carrier and the developer carrier; and
biasing members configured to respectively bias the bearing members toward a rotational axis of the developer carrier.
